(19) United States
(12) Patent Application Publication
(10) Pub. No.: US 2005/0227733 A1
(43) Pub. Date: Oct. 13, 2005

(54) Adjustable basedband processing of telecommunications signals

(75) Inventors: Timothy John Lunn, Cambridge (GB); Alan Geoffrey Carr, Surrey (GB)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: PA Consulting Services Limited, Melborne, Herfordshire (GB)

(21) Appl. No.: 10/504,604

(22) PCT Filed: Feb. 13, 2003
(86) PCT No.: PCT/GB03/00629

§ 371 Date: Apr. 20, 2005

(30) Foreign Application Priority Data
Feb. 13, 2002 (GB) 0203410.6

(51) Int. Cl. H04M 1/00

(52) U.S. Cl. 455/561

(57) ABSTRACT

In a basestation, both chip and symbol rate processing are performed within the same DSP. The tasks involved in these baseband processing operations are performed using functions selected from groups of functions available for performing certain tasks. For example, demodulation can be performed using either a rake receiver function or an adaptive equalisation function, the choice being made according to the prevailing circumstances, for example, on the basis of such factors as available baseband processing power, delay spread and spreading factor.

The invention relates to a basestation for a telecommunications network, and to the baseband processing of a telecommunications signal within such a basestation at both chip and symbol rate.

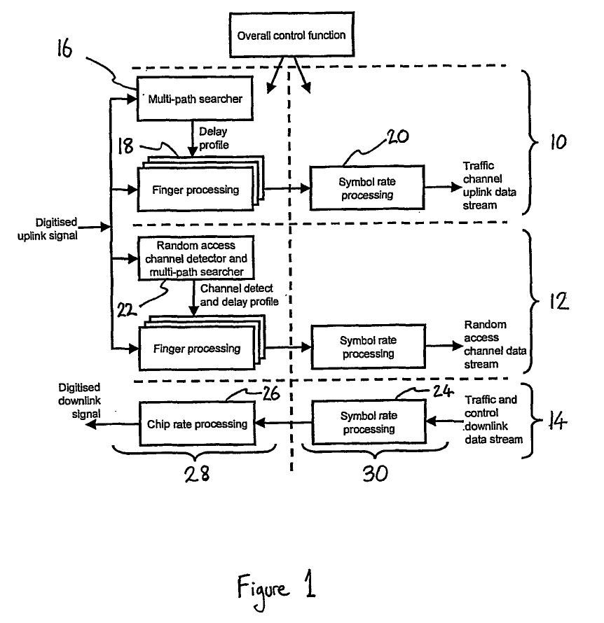

FIG. 1 illustrates the structure of the core part of the baseband processing section of a conventional CDMA basestation. The baseband processing section shown in FIG. 1 has three basic subsections. These are an uplink traffic channel processing subsection 10, an uplink random access channel processing subsection 12 and a downlink traffic channel processing subsection 14. The uplink traffic channel carries voice and data from a subscriber unit to the basestation. The uplink random access channel conveys control information and associated data from a subscriber unit to the basestation and supports random access by the subscriber unit to the basestation. The downlink traffic channel carries voice and data from the basestation to the subscriber unit. There are other parts to the baseband processing section of the basestation, e.g. to process common downlink channels.

The uplink traffic channel processing subsection 10 consists of a multipath searcher 16 to detect multipath components in the uplink traffic channel and a finger processing section 18 to despread signals received in the uplink traffic channel to correct for different channel paths and to form a combined output. The uplink traffic channel processing subsection 10 also comprises a symbol rate processing stage 20 to convert the raw data output by the finger processing section 18 into formatted uplink data.

The processing that is performed in the uplink random access channel processing subsection 12 is similar to that performed in the uplink traffic channel processing subsection 10, except that the multipath searcher 22 in subsection 12 also includes a random access channel detector to detect random access bursts transmitted by subscriber units. The random access channel detection is normally implemented by means of a random access preamble detector.

The downlink traffic channel processing subsection 14 comprises a symbol rate processing section 24 to encode and format the data to be transmitted, followed by a chip rate processing section 26 to spread the signal output by the symbol rate processing section 24 to the chip rate.

As is apparent from FIG. 1, the baseband processing performed within a typical CDMA basestation can be separated into two divisions, a first division 28 carrying out chip rate processing and a second division 30 carrying out symbol rate processing operations. Conventionally, the chip rate processing of the first division 28 is done using a combination of dedicated electronic hardware (for example, in the form of ASICs or FPGAs) and programmable DSP processing. The symbol rate processing of the second division 30 is normally performed using programmable digital signal processor and general-purpose processors. Thus, the chip rate processing of the first division 28 and the symbol rate processing of the second division 30 are performed on different devices. Generally, this holds true even where the baseband processing section is constructed from discrete electronic devices or where dedicated chip sets have been developed to implement the baseband processing.

The present invention seeks to improve the manner in which basestation baseband processing is implemented.

According to a first aspect, the invention provides a basestation for a telecommunications network, comprising digital signal processing means for performing both chip and symbol rate processing of telecommunications signals, wherein the basestation is capable of changing a baseband processing function of the digital signal processing means to perform a baseband task in different ways.

Thus, the baseband processing section of a basestation can be adjusted to increase the efficiency of the baseband processing section and the basestation as a whole.

Further, the invention enables a move away from the rigid formulation where the chip rate processing is carried out in a substantially fixed configuration and the bit rate processing is done in software on a digital signal processor.

In one embodiment, the change to the baseband processing function involves adjusting the behaviour of the function. For example, the number of fingers used in a rake receiving process can be adjusted.

In another embodiment, the change to the baseband processing function involves selecting one of a group of functions available to perform said task. For example, a rake receiver function and an adaptive equalisation function could both be available to a basestation for the purpose of demodulating a signal and the basestation could choose the most appropriate of the two demodulation functions to use under the prevailing conditions.

Adjustments to the baseband processing regime within the basestation could be initiated in several ways. For example, the basestation could be provided with control means for instructing the digital signal processing means to adjust its baseband processing routines. Alternatively, the digital signal processing means could be arranged to gather information about the user and/or channel providing a telecommunications signal being processed by the basestation, the digital signal processing means then using said information to adjust at least one baseband processing function operating on said telecommunications signal.

In a preferred embodiment, the basestation according to the invention can choose between the use of a function implementing a rake receiver and a function performing adaptive equalisation in order to demodulate telecommunications signals received at the basestation. Advantageously, the choice of which demodulation function to use may be made on the basis of an assessment made by the digital signal processing means of the user and/or channel providing the signal to be demodulated.

Some of the parameters which may be used to initiate or control changes in the baseband processing performed by the basestation have been discussed above. Additionally or alternatively, the basestation could monitor the demand on, and availability of, baseband processing resources within the basestation and use the results of that assessment to determine if the baseband processing should be adjusted. For example, such a process could be used to ensure that the available baseband processing power within the basestation is fairly distributed amongst the various baseband processing tasks that need to be performed at any one time.

In one embodiment, the digital signal processing means is a digital signal processor (DSP). In another embodiment, the digital signal processing means comprises a plurality of DSPs arranged to share said chip-and symbol rate processing, preferably in a dynamic manner. The plurality of DSPs may be arranged to act together so as to equate to a single, more powerful DSP which performs the chip and symbol rate processing.

The basestation according to the invention is preferably a UMTS basestation, although it will be apparent to the skilled that the basestation could be of another type.

By way of example only, an embodiment of the invention will now be described with reference to the accompanying figures, in which:

FIG. 1 illustrates the structure of the baseband processing section within a conventional CDMA basestation;

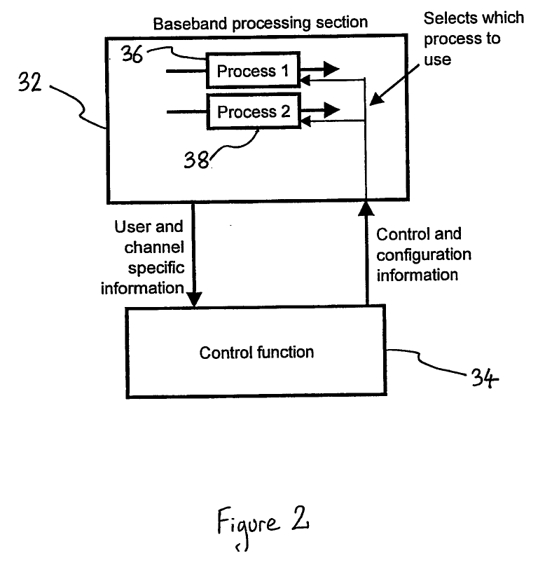

FIG. 2 is a block diagram illustrating how, according to an embodiment of the invention, a function can be selected to perform a given baseband processing task; and

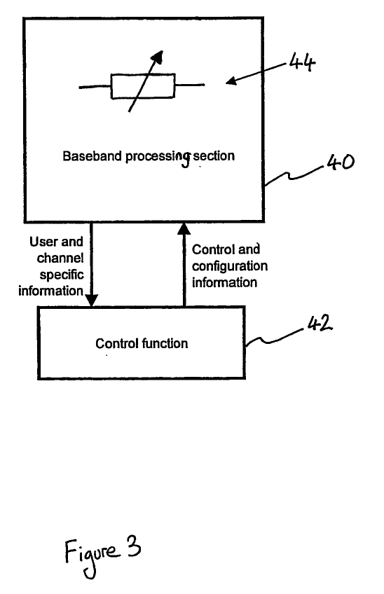

FIG. 3 is a block diagram illustrating how adjustments to baseband processing may, according to an embodiment of the invention, be controlled.

The basestation according to the embodiment of FIG. 2 has a baseband processing section 32 implemented on a DSP and arranged to perform both chip rate and symbol rate processing. The basestation includes a control unit 34 for controlling the adjustment of the baseband processing functions in the baseband processing section 32.

The baseband processing section performs various baseband processing tasks, such as those chip and symbol rate tasks described earlier with reference to FIG. 1. For each of a number of the tasks to be performed by the baseband processing section 32, a group of processes is assigned. Each of the processes in a group is capable of carrying out the baseband processing task with which the group is associated.

FIG. 2 illustrates how a process within a group is selected to perform a particular task. As shown in FIG. 2, a group of two processes 36 and 38 is available for performing the baseband processing task of demodulating an uplink traffic channel. One of the processes, 36, performs the demodulation using a rake receiver technique and the other process, 38, performs the demodulation using an adaptive equalisation technique. The control unit 34 determines which of processes 36 and 38 is to be used for demodulation at any given time. The control unit 34 makes this determination on the basis of user and channel specific information which is generated by the baseband processing section 32 operating on the uplink traffic channel in question. The user and channel specific information received by the control unit 34 is indicative of the delay spread in the signal undergoing demodulation and the spreading factor used by the signal undergoing demodulation. If the delay spread of the signal undergoing demodulation is small (up to a few chip periods) and if a low spreading factor is used by the signal undergoing demodulation, then control unit 34 instructs the baseband processing section 32 to use process 38, namely adaptive equalisation, in the demodulation process as an equaliser may work better under such conditions. Under other conditions, process 36 is used to implement a rake receiver to perform the demodulation.

The control unit 34 selects the appropriate one of processes 36 and 38 for carrying out the demodulation. In the case where other traffic channels are active, the control unit 34 also selects the appropriate demodulation function to use for those users. Thus, the baseband processing section can be configured by the control unit 34 to use a first demodulation process, say a rake receiver, with a first user on a first channel and a second demodulation process, say adaptive equalisation, with a second user on a different traffic channel.

In a variation on the embodiment shown in FIG. 2, different parameters may be provided by the baseband processing section 32 to the control unit 34 to enable the latter to determine which of the processes 36, 38 to use for demodulation. These parameters include, for example, the fade rate of the signal undergoing demodulation and parameters quantifying the noise effecting the signal undergoing demodulation, such as the ratios E_{c}/N₀ and E_{C}/I₀. In fact, the control unit 34 can be provided with rules which select the appropriate demodulation technique in response to any of or any group of the aforementioned parameters that can be provided by the baseband processing section 32.

In the embodiment of FIG. 2, the baseband processing within the baseband processing section 32 is adjusted in response to external control signals originating at the control unit 34. However, it is possible for the control unit 34 to be implemented on the same digital signal processor as the baseband processing section 32.

In the embodiment of FIG. 3, the baseband processing is capable of being changed by adjusting the way in which baseband functions operate, rather than by choosing one function from a group available to perform a given task.

The embodiment of FIG. 3 employs a control unit 42 for controlling the operation of a baseband processing section 40, such as in FIG. 2. However, in the embodiment of FIG. 3, the control unit 42 is arranged to adjust the performance of baseband function 44 to optimise the function's performance given the user/channel specific information supplied from the baseband processing section 40. In this example, the function 44 is a rake receiver process used in the demodulation of signals received at the base station. The control unit 42 is arranged to use information from the baseband processing section to determine how many fingers are used by the rake receiver process.

For example, some users might only have a small number of dominant multipath components, therefore requiring only perhaps one or two fingers to be allocated to them. This frees digital signal processing power for users that are subject to several multipath components to be detected using a greater number of rake fingers, e.g. users at the edge of the basestation's cell that have many multipath components of roughly equal amplitude.

The allocation of the number of fingers is done when a new user is acquired by the basestation. It would also be possible to change the number of fingers dynamically as the channel conditions experienced by users change. The parameters used to control the number of fingers to be allocated to a user include the delay spread of a received signal, the spreading factor applied to a received signal, the E_{C}/N₀ ratio, the E_{C}/I₀ ratio, the recent delay spread history and statistics, and such history/statistics averaged over several previous users of the channel.

Some other tasks that can be rendered configurable will now be discussed.

The best multipath component search strategy to use with a received signal will depend upon several factors describing a particular user and channel. A group of functions for implementing a multipath component search strategy in different ways can be provided and the most appropriate function can be selected depending upon the circumstances. Alternatively, the behaviour of the function performing the multipath search task can be adjusted, rather than swapping one function for another. The different ways available to implement the multipath component search strategy allow the selection of various characteristics of the strategy.

The hierarchy of the search strategy can be made selectable. The baseband processing section can be arranged to select between functions which implement one, two or more levels. The set of rules for controlling changes between the levels in a multilevel search hierarchy may also be rendered selectable. As an example, the system could allow the selection of a two level hierarchy in which one level implements a coarse search to detect major shifts in multipath components and the other level implements a fine search to locate the components accurately and track small changes. The selection of the interval which elapses between repetitions of a search could be allowed. The selection of different intervals for different layers of a hierarchy could be allowed. The range of searching could be allowed to become selectable. The range of searching could be changed depending on the expected temporal distribution of multipath components. Additionally, the system could allow the resolution of the search to be selected dynamically. For example, the system could be allowed to select between 0.25, 0.5 and 1.0 chip resolutions.

There are various criteria that can be used to control the selection of the appropriate nature of a particular aspect of the search strategy. For example, the selection could be controlled by the amplitude and speed of movement of multipath components, multipath component birth and death statistics, the delay spread in the received signal, the spreading factor applied to the received signal, the E_{C}/N₀ ratio, the E_{C}/I₀ ratio, the recent search history of a particular user or channel, and the history of a channel averaged over several previous users.

The task of combining the outputs of individual rake fingers can also be made the subject of a group of selectable functions. For example, functions could be made available to perform finger combination using a maximum ratio combining scheme, a maximum likelihood scheme or an optimal combining scheme based on the estimation of the statistical properties of the interference affecting the channel. The choice of the function to be employed could be dictated by, for example, the E_{C}/N₀ ratio, the E_{C}/I₀ ratio or the bit error rate of the channel.

In a similar manner, other baseband processing tasks can be made configurable. For example, the channel estimation strategy could be made adaptive. This could include changing the filtering strategy for channel estimates, i.e. implementing a variable forgetting factor. The base station may be arranged to implement a power control scheme for, e.g., economising on the power used when transmitting to subscriber units and/or for instructing subscriber units to adjust their transmission power so that signals received at the base station have similar or substantially equal power levels. The step size and update interval used for adjusting the transmit power levels in such a scheme could be made adaptable. Similarly, a transmit diversity scheme using multiple antennae could be implemented using selectable functions, as could the random access channel search strategy (in a similar manner to the foregoing discussion of the traffic channel search strategy), the frequency of automatic frequency control updates, and the chip level signal sampling rate.

A further factor that can be used to influence the selection of the way in which a given baseband processing task is performed is the available baseband processing power within the basestation. For example, the system can be arranged so that in conditions of high demand for baseband processing power, the system aims to reduce the amount of baseband processing resources consumed by dictating that a baseband processing task is performed in the one of the available ways which best conserves baseband processing resources.

It will also be apparent that, although the arrangements for selectable and adjustable functions have been described separately, such options for configuring baseband processing routines can be combined. For example, as regards demodulation, a selection between a rake receiver process and an equaliser could be performed with the number of rake fingers in the rake receiver process being adjustable if this technique is selected for use.

1. A basestation for a telecommunications network, the basestation comprising a digital signal processing equipment for performing both chip and symbol rate processing of telecommunictions signals, wherein several implementations are available to the basestation for performing a given baseband task and the basestation is structured and arranged to select one of the implementations and then execute the selected implementation through the digital signal processing equipment.

2. A basestation according to claim 1, wherein the basestation is structured and arranged to make said selection in response to information gathered about a user and/or channel providing a telecommunications signal on which said task is to be performed.

3. A basestation according to claim 2, wherein the basestation is structured and arranged to perform measurements on said telecommunications signal to obtain said information.

4. A basestation according to claim 2, wherein the digital signal processing equipment is structured and arranged to conduct said gathering.

5. A basestation according to claim 2, wherein the digital signal processing equipment is structured and arranged to make said selection on the basis of said information.

6. A basestation according to claim 2, further comprising a controller for making said selection on the basis of said information.

7. A basestation according to claim 1, wherein said task is the demodulation of a telecommunications signal received at the basestation.

8. A basestation according to claim 7, wherein said implementations for performing said task include at least one of a rake receiver technique and an adaptive equalisation technique.

9. A basestation according to claim 7, wherein the basestation is structured and arranged to select the implementation of said task at least partly on the basis of at least one of the noise and/or interference affecting the signal undergoing demodulation, the delay spread of the signal undergoing demodulation, the fade rate of the signal undergoing demodulation, the spreading factor of the signal undergoing demodulation and the available baseband processing power within the basestation.

10. A basestation according to claim 1, wherein said task is searching for multi-path components of a signal received at the basestation.

11. A basestation according to claim 10, wherein said implementations for performing said task allow at least one of the hierarchy, update interval, range and resolution of the search to be selected.

12. A basestation according to claim 10, wherein the basestation is structured and arranged to select the implementation of said task at least partly on the basis of at least one of the amplitude of multipath components of the searched signal, birth and death statistics of multipath components of the searched signal, the delay spread of multipath components of the searched signal, the spreading factor of the searched signal, the noise and/or interference affecting the searched signal, the search history of the user or channel providing the received signal undergoing searching and available baseband processing power within the basestation.

13. A basestation according to claim 1, wherein said task is combining rake finger outputs representing a telecommunications signal received at the basestation.

14. A basestation according to claim 13, wherein said implementations for performing said task include at least one of a miximal likelihood combiner, a maximum ratio combiner and a function which combines the rake fingers in a manner dependent upon the estimated statistical properties of the interference.

15. A basestation according to claim 13, wherein the basestation is structured and arranged to select the implementation of said task at least partly on the basis of the noise and/or interference affecting the telecommunications signal received at the basestation.

16. A basestation according to claim 1, wherein said task is demodulating a telecommunications signal received at the basestation using a rake receiving process.

17. A basestation according to claim 16, wherein said implementations for performing said task comprise performing the demodulation using different number of rake fingers.

18. A basestation according to claim 16, wherein the basestation is structured and arranged to select the implementation of said task at least partly on the basis of at least one of the delay spread of the signal undergoing demodulation, the spreading factor of the signal undergoing demodulation, the noise and/or interference affecting the signal undergoing demodulation, delay spread history and/or statistics of the signal undergoing demodulation and the available baseband processing power at the basestation.

19. (canceled)
